(19) United States
(12) Patent Application Publication
(10) Pub. No.: US 2011/0106457 A1
(43) Pub. Date: May 5, 2011

(54) Methods, systems, and computer program products for performing structural screening

(76) Inventors: Richard C. McNealy, Katy, TX (US); Ming Gao, Houston, TX (US); Mohammed Jaarah, Dubai (AE)

(21) Appl. No.: 11/285,337

(22) Filed: Nov. 21, 2005

(51) Int. Cl. G06F 19/00; G01N 29/04

(52) U.S. Cl. 702/39; 73/592

(57) ABSTRACT

Methods, systems, and computer program products for performing structural screening. Methods include applying pre-defined filter criteria to measurements resulting from an inspected structure operable for eliminating measurement data falling below a designated threshold. Methods further include identifying a baseline defect size associated with the inspected structure. The baseline defect size indicates a largest defect capable of being undetected during inspection. Methods also include identifying tolerance levels relating to the inspected structures factoring in the baseline defect size and attributes of the inspected structure, comparing results of the applying pre-defined filter criteria with tolerance levels identified, and determining a risk of cracking for the inspected structure based upon the comparing.

### BACKGROUND OF THE INVENTION

Exemplary embodiments relate generally to integrity management of underground structures, and more particularly, to methods, systems, and computer program products for performing structural screening.

Over time, underground structures (e.g., pipelines) are inevitably subject to damage such as stress corrosion cracking (SCC) which may be caused by factors including environmental abuse, coating disbondments, manufacturing defects, soil movements or instability, and damage by third-party entities. Existing cracks in these structures may be further aggravated by, for example, cyclical loads and the stress ratios placed on these loads.

Owners and other individuals responsible for these structures maintain integrity management plans (IMPs) for addressing maintenance procedures and issue resolution. These procedures may include processes and recommended tools for performing routine maintenance, assessments, and corrective activities for ensuring the continued operation of the structures, as well as for ensuring environmental and public safety relating to these operations. Existing procedures can be very expensive, invasive, and laborious. For example, in a pipeline environment, determining SCC by physical inspection often requires extensive excavation and manual examination by the human eye. Further, many existing tools and processes are designed to address or uncover one or more specific types of defects or are geared toward a specific type of structure, and are not equipped to handle the variety of known issues, defects, and structural types that are in operation today.

There are situations driven by, e.g., regulatory compliance or risk management, whereby the confirmation or absence of possible damage to these structures is required wherein detection and sizing is relegated to a secondary exercise in those cases where the threat of damage has first been validated. The application of flaw detection and sizing using various tools, testing procedures, and screening processes can be very expensive and impractical for systems comprising large numbers of individual structures, particularly when there is no established history of damage in the structural system.

It is desirable, therefore, to provide a more efficient and cost-effective means for implementing structural screening processes.

### BRIEF DESCRIPTION OF THE INVENTION

Exemplary embodiments relate to methods, systems, and computer program products for performing structural screening. Methods include applying pre-defined filter criteria to measurements resulting from an inspected structure operable for eliminating measurement data falling below a designated threshold. Methods further include identifying a baseline defect size associated with the inspected structure. The baseline defect size indicates a largest defect capable of being undetected during inspection. Methods also include identifying tolerance levels relating to the inspected structures factoring in the baseline defect size and attributes of the inspected structure, comparing results of the applying pre-defined filter criteria with tolerance levels identified, and determining a risk of cracking for the inspected structure based upon the comparing.

Systems for performing structural screening include a host system in communication with a storage device. The storage device houses measurements resulting from an inspected structure, pre-defined filter criteria, and attributes of the inspected structure. The system also includes a structural analysis application executing on the host system. The structural analysis application applies the pre-defined filter criteria to the measurements operable for eliminating measurement data falling below a designated threshold. The structural analysis application also identifies a baseline defect size associated with the inspected structure, which indicates a largest defect capable of being undetected during inspection. The structural analysis application further identifies tolerance levels relating to the inspected structure. The tolerance levels factor in the baseline defect size and the attributes. Additionally, the structural analysis application compares results of the applying the pre-defined filter criteria with tolerance levels identified and determines a risk of cracking for the inspected structure based upon the comparing.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of a system upon which the structural analysis system may be implemented in exemplary embodiments;

FIG. 2 is block diagram of database tables utilized by the structural analysis system in exemplary embodiments of the present invention; and

FIG. 3 is a flow diagram describing a process for screening structures for damage in exemplary embodiments.

### DETAILED DESCRIPTION OF THE INVENTION

The structural analysis system implements a screening and analysis process for managing underground structures. Current inspection measurement data relating to a structure and its condition are screened along with pre-defined susceptibility attributes (i.e., filter criteria) and then analyzed in order to determine a threat or presence of damage. The structural analysis system provides an economical solution for maintenance of underground structures that may be conducted within a short cycle time and which provides a reasonable level of confidence in the results. For example, if no colonies are reported as a result of the implementation of the structural analysis system, a confidence level of, e.g., 71%-94% that the structure is free of cracks, may be inferred.

The structural analysis system may be implemented for any underground structure that is subject to stress and the formation of cracks in colonies. For purposes of illustration, however, the structural analysis system will be described herein with respect to pipelines.

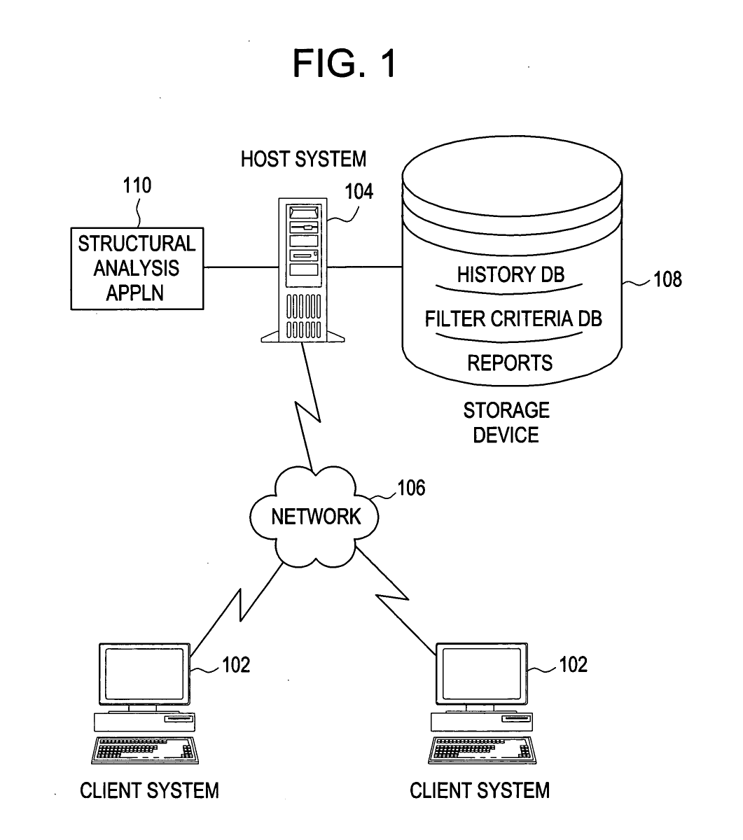

Turning now to FIG. 1, a system upon which the structural analysis system may be implemented in exemplary embodiments will now be described. The system depicted in FIG. 1 includes one or more user systems 102 through which users at one or more geographic locations may contact the host system 104. The host system 104 executes computer instructions for managing structure-related data and the user systems 102 are coupled to the host system 104 via a network 106. Each user system 102 may be implemented using a general-purpose computer executing a computer program for carrying out the processes described herein. The user systems 102 may be personal computers (e.g., a lap top, a personal digital assistant) or host attached terminals. If the user systems 102 are personal computers, the processing described herein may be shared by a user system 102 and the host system 104 (e.g., by providing an applet to the user system 102).

The network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. A user system 102 may be coupled to the host system through multiple networks (e.g., intranet and Internet) so that not all user systems 102 are coupled to the host system 104 through the same network. One or more of the user systems 102 and the host system 104 may be connected to the network 106 in a wireless fashion. In one embodiment, the network is an intranet and one or more user systems 102 execute a user interface application (e.g. a web browser) to contact the host system 104 through the network 106. In another exemplary embodiment, the user system 102 is connected directly (i.e., not through the network 106) to the host system 104 and the host system 104 is connected directly to or contains the storage device 108.

The storage device 108 includes data relating to structures and integrity management information and may be implemented using a variety of devices for storing electronic information. It is understood that the storage device 108 may be implemented using memory contained in the host system 104 or it may be a separate physical device. The storage device 108 is logically addressable as a consolidated data source across a distributed environment that includes a network 106. Information stored in the storage device 108 may be retrieved and manipulated via the host system 104 and/or via the user system 102. A data repository containing structure history information, filter criteria information for screening history data, and reports is located on the storage device 108.

In exemplary embodiments of the present invention, the host system 104 operates as a database server and coordinates access to application data including data stored on the storage device 108.

The host system 104 depicted in FIG. 1 may be implemented using one or more servers operating in response to a computer program stored in a storage medium accessible by the server. The host system 104 may operate as a network server (e.g., a web server) to communicate with the user system 102. The host system 104 handles sending and receiving information to and from the user system 102 and can perform associated tasks. The host system 104 may also include a firewall to prevent unauthorized access to the host system 104 and enforce any limitations on authorized access. For instance, an administrator may have access to the entire system and have authority to modify portions of the system. A firewall may be implemented using conventional hardware and/or software as is known in the art.

The host system 104 may also operate as an application server. The host system 104 executes one or more computer programs (e.g., the structural analysis application 110) for implementing the screening functions described herein. Processing may be shared by the user system 102 and the host system 104 by providing an application (e.g., java applet) to the user system 102. Alternatively, the user system 102 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

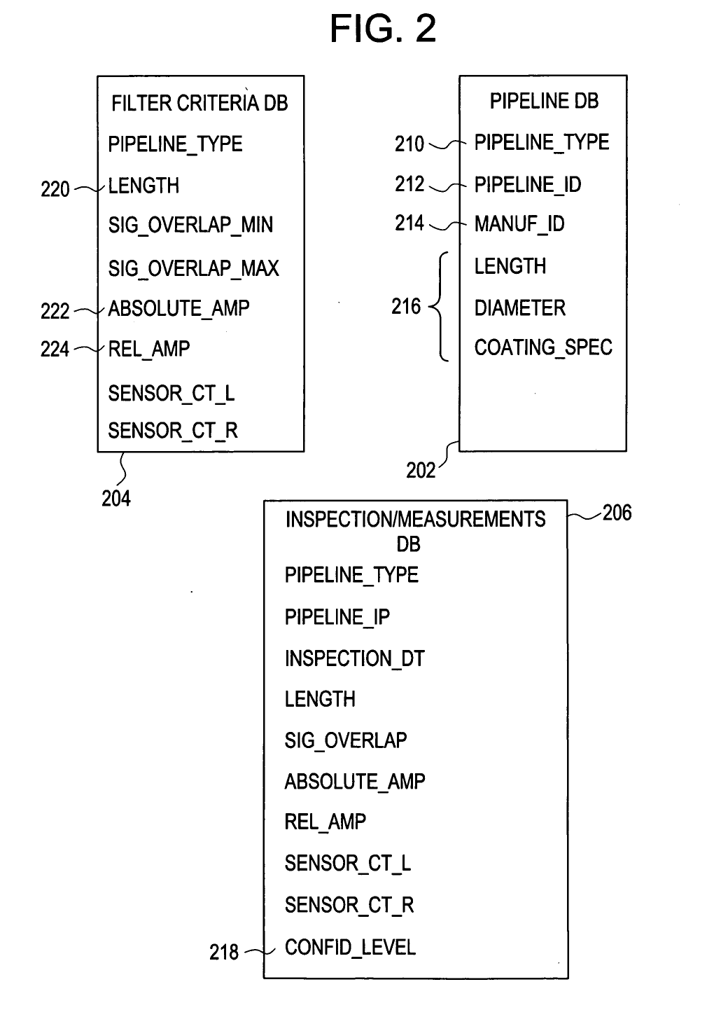

FIG. 2 is a block diagram of database tables containing structure-related data that are utilized by exemplary embodiments of the present invention. The structure-related data provided in FIG. 2 represents pipeline data. However, the data fields shown in FIG. 2 may be modified to represent any type of structure subject to screening as described above. The tables are stored within one or more databases that are located on the storage device 108. Table 202 is a pipeline database table that includes a record of attributes for each pipeline maintained in the system. Each record may include a variety of fields of information relating to a particular pipeline. Examples of fields that may be maintained in the pipeline database include PIPELINE_TYPE 210 for identifying a particular type of pipeline, PIPELINE_ID 212 for identifying a specific pipeline, MANUFACTURER_ID 214 for identifying the manufacturing entity of the pipeline, as well as various dimensions and specifications/composition (e.g., diameter, length, coating materials, operating pressure limitations, etc.) of the pipelines manufactured (216).

Table 204 includes a record for each pipeline type maintained in the system. Filter criteria are applied to each pipeline in order to determine a minimum threshold for performing an analysis as described further herein. The filter criteria may include elements such as length, signal overlap (minimum and maximum values), absolute amplitude, relative amplitude, and left/right sensor counts. The length field 220 contains a value of the length of a “crack-like” or “crack field” type anomaly detected by the ultrasonic crack detection tool. Relative amplitude (REL_AMP field 224) and absolute amplitude (ABSOLUTE_AMP field 222) are measures of signal strength and are related to the depth of the anomaly. These values are used in the characterization of the anomaly, i.e., crack-like or crack field.

Table 206 includes a record for each inspection performed on a pipe/pipeline. A history of inspections may be maintained (e.g., several records) for each pipe/pipeline as needed. A variety of measurements and information fields may be provided in this table as desired. The measurements utilized by the processes of the invention include length, signal overlap, absolute amplitude, relative amplitude, and left/right sensor counts. Moreover, one or more fields (e.g., PIPELINE_TYPE, PIPELINE_ID, INSPECTION_DT, etc.) may be used as a key to identify corresponding database tables. Many of the fields provided in inspection table 206 may overlap with fields provided in the filter criteria table 204 as shown in FIG. 2.

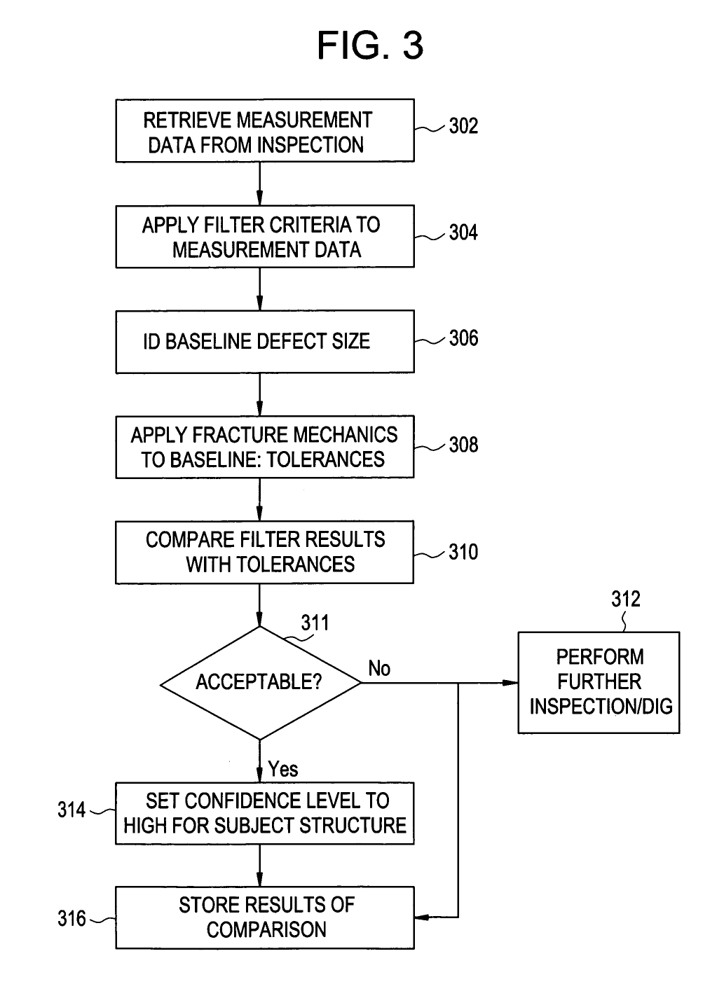

Turning now to FIG. 3, a flowchart describing a process for implementing the screening of structures in exemplary embodiments will now be described. Inspection procedures are implemented on selected structures (e.g., pipelines or portions of a pipeline) utilizing, e.g., an in-line ultrasonic inspection tool or other suitable instrument. The measurement data resulting from this inspection is stored in the history database of storage device 108 via, e.g., measurement table 206, and then provided to the structural analysis application 110 at step 302.

The structural analysis application 110 then performs a screening of the inspection data for the designated structure by applying the filter criteria (from table 204) at step 304. Step 306 includes applying pre-defined susceptibility attributes, i.e., minimum or maximum values relating to length, signal overlap, absolute amplitude, relative amplitude, and left/right sensor counts to the inspection data in order to filter out measurements that fall below an established threshold for analysis.

A baseline defect size (length and width) is identified which provides a conservative probability of exceedance from the distribution of historic defects obtained from, e.g., in-line tool inspections, at step 306. This baseline defect size represents the largest defect that may be missed or otherwise undetectable through application of the screening analysis. It will be understood that the baseline defect size may vary according to selected limits of detection and a level of confidence required/desired for a particular application.

At step 308, a fracture mechanics evaluation (e.g., API RP579 level 2) is applied to the structural attributes factoring in the baseline defect size to determine what combinations of sizes, fracture toughness, and operating pressure may tolerate crack defects of the baseline defect size. The fracture mechanics evaluation may be a proprietary algorithm/tool or may include the method provided in patent application Ser. No. 10/710,702, entitled “Method for Detecting Leak Before Rupture in a Pipeline”, filed on Jul. 29, 2004, and is incorporated by reference herein in its entirety.

The results of the evaluation provide calculated tolerances for the structure given the presumption of a baseline defect.

At step 310, the results of the filtering (from step 304) are compared with the tolerance data resulting from step 308. The filtering results are analyzed in conjunction with the tolerances in order to determine the likelihood of cracking or SCC in the structure, e.g., the size of SCC crack like or crack field pipe wall anomaly that may cause failure may be determined by application of fracture mechanics evaluation). Given the knowledge of a given structure to tolerate a hypothetical or undiscovered crack (e.g., from data values provided in databases 202 and 204), a database of known features associated with cracking or SCC (e.g., values provided in database 206) is queried and analyzed.

The anomaly lengths and widths for crack-like features recorded in the database (e.g., database 206) may be analyzed using conventional statistical analysis to determine the probability of flaws remaining in a given structure if the data for that particular structure was subjected to an analysis of only one criteria, that being length of signal indicating a defect.

If the results of the analysis indicate a high risk of cracking or SCC at step 311, the structure may be scheduled for further inspection, testing, or related activity at step 312, and the results of the analysis are stored at step 316. Otherwise, the confidence level (e.g., CONFID_LEVEL field 218) is set to high (e.g., 71%-94%), indicating a low risk of cracking or SCC present in the structure at step 314. The results of the analysis are stored in storage device 108 of FIG. 1 at step 316. Reports may be generated therefrom if desired.

As indicated above, the screening and analysis process provided by the structural analysis system provides an economical solution for maintenance of underground structures that may be conducted within a short cycle time and which provides a reasonable level of confidence in the results. Current data relating to a structure and its condition are screened along with pre-defined susceptibility attributes and then analyzed in order to determine a threat or presence of cracking or SCC.

As described above, the embodiments of the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. The technical effect of the executable code is to provide screening of pipelines for enabling the early detection and management of stress corrosion and cracking.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for performing structural screening, comprising:
applying pre-defined filter criteria to measurements resulting from an inspected structure, the applying pre-defined filter criteria operable for eliminating measurement data falling below a designated threshold;
identifying a baseline defect size associated with the inspected structure, the baseline defect size indicating a largest defect capable of being undetected during inspection;
identifying tolerance levels relating to the inspected structure, the tolerance levels factoring in the baseline defect size and attributes of the inspected structure; and
comparing results of the applying pre-defined filter criteria with tolerance levels identified and determining a risk of cracking for the inspected structure based upon the comparing.

2. The method of claim 1, wherein the pre-defined filter criteria include at least one of length, signal overlap, absolute amplitude, relative amplitude, left sensor count, and right sensor count.

3. The method of claim 1, wherein the baseline defect size is identified by length and width.

4. The method of claim 1, wherein the baseline defect size represents a largest defect that is undetectable by an ultrasonic inspection tool.

5. The method of claim 4, wherein the baseline defect size is modified according to selected limits of detection and a selected level of confidence.

6. The method of claim 1, wherein the identifying tolerance levels is accomplished by performing a fracture mechanics evaluation on the attributes of the inspected structure including determining combinations of sizes, fracture toughness, and operating pressures that are capable of withstanding crack defects coinciding with the baseline defect size.

7. The method of claim 1, wherein the attributes of the inspected structure include at least one of size, composition, and applied operating pressure.

8. The method of claim 1, wherein the inspected structure is at least one of:
a gas pipeline;
a liquid pipeline;
a steam pipeline;
a pipe; and
a conduit.

9. The method of claim 1, wherein the defect subject to the screening includes colonies of cracks formed in the structure.

10. A system for performing structural screening, comprising:
a host system in communication with a storage device, the storage device housing measurements resulting from an inspected structure, pre-defined filter criteria, and attributes of the inspected structure; and
a structural analysis application executing on the host system, the structural analysis application performing:
applying the pre-defined filter criteria to the measurements operable for eliminating measurement data falling below a designated threshold;
identifying a baseline defect size associated with the inspected structure, the baseline defect size indicating a largest defect capable of being undetected during inspection;
identifying tolerance levels relating to the inspected structure, the tolerance levels factoring in the baseline defect size and the attributes; and
comparing results of the applying the pre-defined filter criteria with tolerance levels identified and determining a risk of cracking for the inspected structure based upon the comparing.

11. The system of claim 10, wherein the pre-defined filter criteria include at least one of length, signal overlap, absolute amplitude, relative amplitude, left sensor count, and right sensor count.

12. The system of claim 10, wherein the baseline defect size is identified by length and width.

13. The system of claim 10, wherein the baseline defect size represents a largest defect that is undetectable by an ultrasonic inspection tool.

14. The system of claim 13, wherein the baseline defect size is modified according to selected limits of detection and a selected level of confidence.

15. The system of claim 10, wherein the identifying tolerance levels is accomplished by performing a fracture mechanics evaluation on the inspected structure including determining combinations of sizes, fracture toughness, and operating pressures that are capable of withstanding crack defects coinciding with the baseline defect size.

16. The system of claim 10, wherein the attributes of the inspected structure include at least one of size, composition, and applied operating pressure.

17. The system of claim 10, wherein the inspected structure is at least one of:
a gas pipeline;
a liquid pipeline;
a steam pipeline;
a pipe; and
a conduit.

18. The system of claim 10, wherein the defect subject to the screening includes colonies of cracks formed in the structure.
